(19) United States
(12) Patent Application Publication
(10) Pub. No.: US 2009/0228545 A1
(43) Pub. Date: Sep. 10, 2009

(54) ONLINE MOBILE APPLICATIONS CAPABLE OF DEALING WITH OCCASIONAL DISCONNECTS

(76) Inventors: Jose A. Mendez, San Juan, PR (US); Carlos Juan Soltero, Caguas, PR (US); Jun Dai, Suwanee, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/397,985

(22) Filed: Mar. 4, 2009

Related U.S. Application Data
(60) Provisional application No. 61/034,560, filed on Mar. 7, 2008.

(51) Int. Cl. G06F 15/16

(52) U.S. Cl. 709/202

(57) ABSTRACT

A technique for building applications consuming web services; where users can use the application while being online or offline, while maintaining the impression and feel of an online application, and without the requirements of a synchronization engine.

### CROSS-REFERENCE TO RELATED APPLICATIONS

This application claims the benefit of the priority date of the United States Provisional application for patent that was filed on Mar. 7, 2008 and assigned Ser. No. 61/034,560.

### BACKGROUND OF THE INVENTION

The present disclosure is related to the field of online mobile applications and, more specifically, is directed towards developing online mobile applications based on service oriented architectures, which can operate even in an environment with occasional disconnects and further, that can operate in this fashion without the need of a synchronization engine.

Mobile applications are usually architected with connectivity options in mind. Mobile offline-capable applications often use synchronization techniques, while strictly online applications are usually developed using Web technologies. In Enterprise Service Oriented Architecture environments, another type of online mobile application can be built by consuming web services, and without the need to have business logic hosted on the device. These “smart client” applications rely on functionality exposed via web services for proper execution. However, when the services are not available, these applications traditionally cannot continue their execution.

The main problem internet-enabled mobile devices face is that, due to their nature, they are moved around between areas with connectivity, and areas where there is a poor connection or none at all. This problem is evident in current browser-based web applications, which simply cannot be used without a connection. However, in online rich applications, a presentation layer runs on the device itself, and depends extensively on web services running on a server.

Techniques that have been presented as a means to address connectivity issues in a mobile environment include (a) moving the data between the server and the mobile device and/or (b) creating a web application. Both of these approaches have their own faults and short comings. For instance, moving the data between the server and the mobile device can cause synchronization problems and may result in increasing the cost of the mobile device or otherwise consuming its memory resources. Creating web applications on the other hand alleviate these problems with data relocation but, they rely heavily upon connectivity. For instance, when a mobile application needs to consume web services to continue operation, when connectivity is lost the application can no longer be operated. What is needed in the art is a mobile device oriented solution that allows mobile applications that consume web services to operate in an online and offline mode in such a manner that the operation between these modes is seamless to the user.

### BRIEF SUMMARY

Aspects and features of the embodiments disclosed herein are directed towards building applications consuming web services; where users can use the application while being online or offline, while maintaining the impression and feel of an online application, and without the requirements of a synchronization engine.

One aspect of an embodiment is a technique to build applications that consume web services, but provides the ability for users or equipment to operate regardless of whether they are online or offline. In addition, these applications maintain the sense, from a user's perspective, that they are operating as online applications. Further, these applications accomplish this online appearance without requiring complicated and expensive synchronization engines, techniques or functionality.

In general, various embodiments may operate in such a manner as to make the service response information available at all times, even during disconnects, and then allow the submission of data to occur as soon as a connection is available.

### BRIEF DESCRIPTION OF THE SEVERAL VIEWS OF THE DRAWING

FIG. 1 is a system block diagram illustrating the main components of an environment and embodiment which provides caching capabilities.

FIG. 2 is a system block diagram illustrating a fully connected mode of operation for the system illustrated in FIG. 1.

FIG. 3 is a system block diagram illustrating a connected mode of operation, similar to that illustrated in FIG. 2 for the system illustrated in FIG. 1, with the exception that previously stored responses are served up to the application logic.

FIG. 4 is a system block diagram illustrating a connected mode of operation, similar to that illustrated in FIG. 3 for the system illustrated in FIG. 1, with the exception that previously stored responses and real-time response are both served up to the application logic.

FIG. 5 is a system block diagram illustrating a disconnected mode of operation for the system illustrated in FIG. 1.

FIG. 6 is a system block diagram illustrating the operation of the coordination agent in a fully connected mode of operation for the system illustrated in FIG. 1.

### DETAILED DESCRIPTION OF VARIOUS EMBODIMENTS

Disclosed embodiments, as well as features and aspects thereof, are directed towards the provision of web service consuming mobile applications that enable a user to use the application while being online, offline or temporarily disconnected or disabled and yet, maintaining the impression and feel of an online application. Furthermore, this online appearance or disconnect agnosticism in the operation of the application is accomplished without the need of a synchronization engine.

Now turning to the figures in which like labels refer to like elements throughout the several views, various embodiments, aspects and features of the present invention are described.

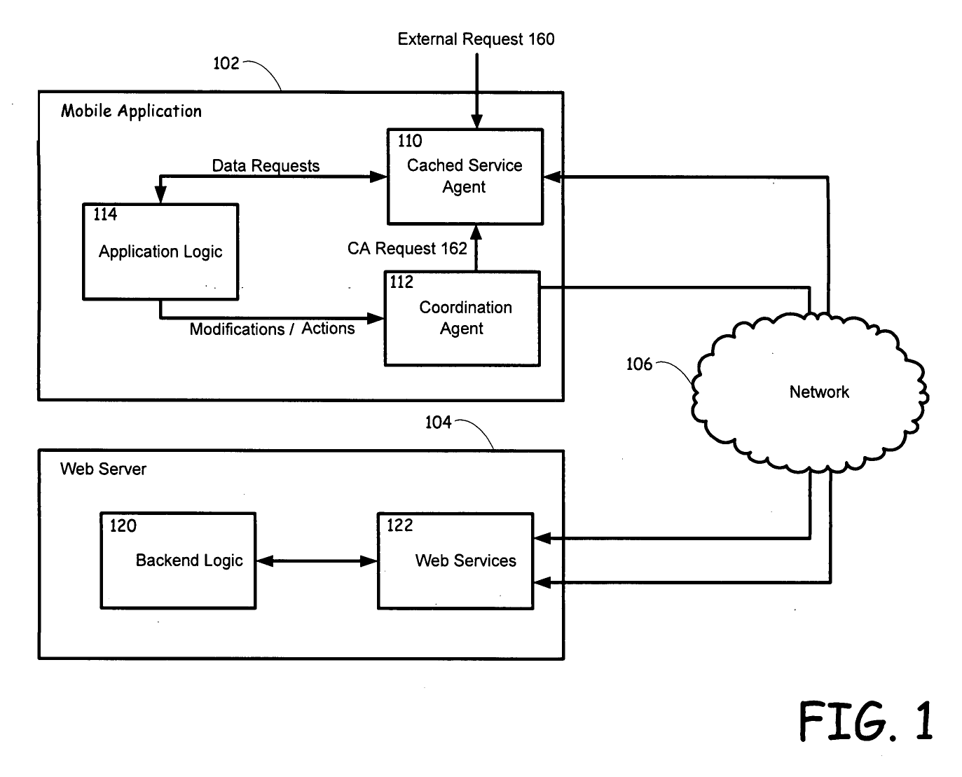

FIG. 1 is a system block diagram illustrating the main components of an environment and embodiment which provides caching capabilities. A mobile application 102 which may be running or active on a mobile device interfaces with a web server 104 through a network 106. The mobile application 102 includes a Cached Service Agent 110 component which provides caching capabilities and a Coordination Agent 112 allowing for the coordination of multiple submissions. The mobile application 102 provides for inbound traffic when the mobile device needs data and for outbound traffic when the mobile device sends data to the server.

The web server 104 which may be operating on a server computer platform includes backend logic 120 and one or more web services 122 that are accessed by or exercised by the mobile application 102 over network 106. The mobile application 102 includes application logic 114 that interacts with the web services 122 through the cached service agent 110 and the coordination agent 112.

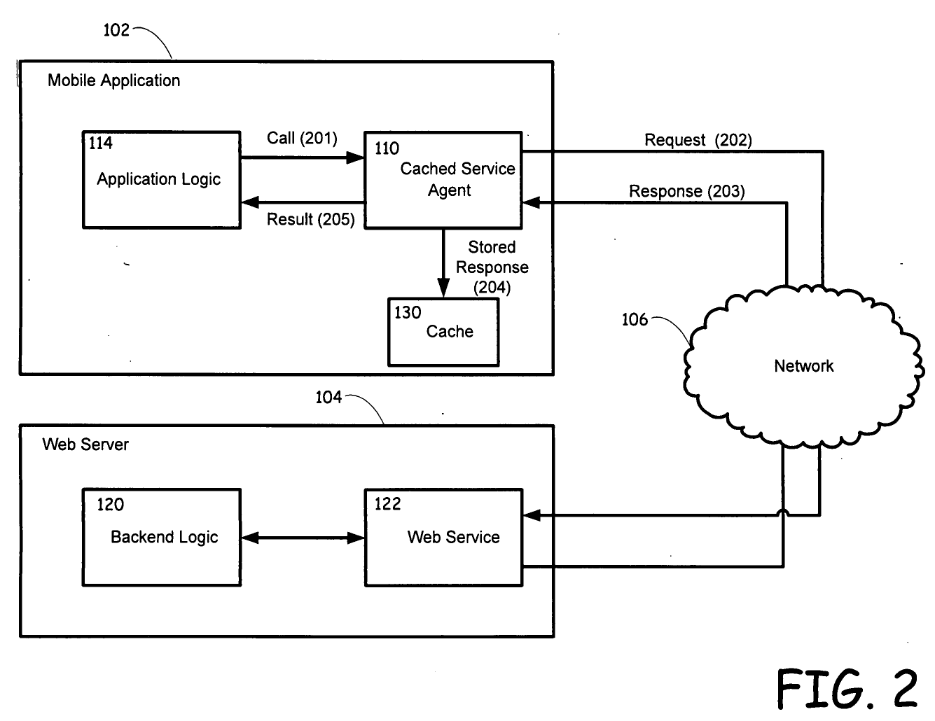

The cached service agent 110, which serves web service execution results to the application logic 114, provides multiple operation modes. These modes are more specifically described in conjunction with FIGS. 2-5.

Prior to further describing the operation of the system, an exemplary environment or use is presented as a non-limiting example to facilitate understanding of the various aspects and features of the various embodiments. For instance, suppose the mobile application is generally designed to support a maintenance operation in which operators or users must visit various sites, perform actions and then report back to a central location. Upon turning on the mobile application at the onset of the day, a subset of the information necessary for the day's operations can be obtained by the mobile device. For instance, this could include a list of sites to visit. In operation, as the user visits sites, service orders are pulled up, service confirmation information is entered into the system (eg. I entered site A, duration of time: 3.5 hours, tasks 1, 2, and 3 were completed). During the course of the day's operation, the mobile device may enter and exit connectivity modes. When connected, the information is passed to the web server and results are obtained. When not connected, the data is queued or stored in the mobile device until proper connectivity is attained.

One aspect of various embodiments is that the backend functionality of the web services are exposed and the necessary operations for the mobile device to work offline can be installed on the mobile device. This is attained through the use of identifying operations on data that occur in online modes of operation, and storing the responses for future use. Then when the mobile device is in offline mode or temporarily disconnected, these stored or cached responses can be used, along with any necessary application functional logic stored on the mobile device, to provide operation that, from a user's perspective, is the same as if the mobile device is connected.

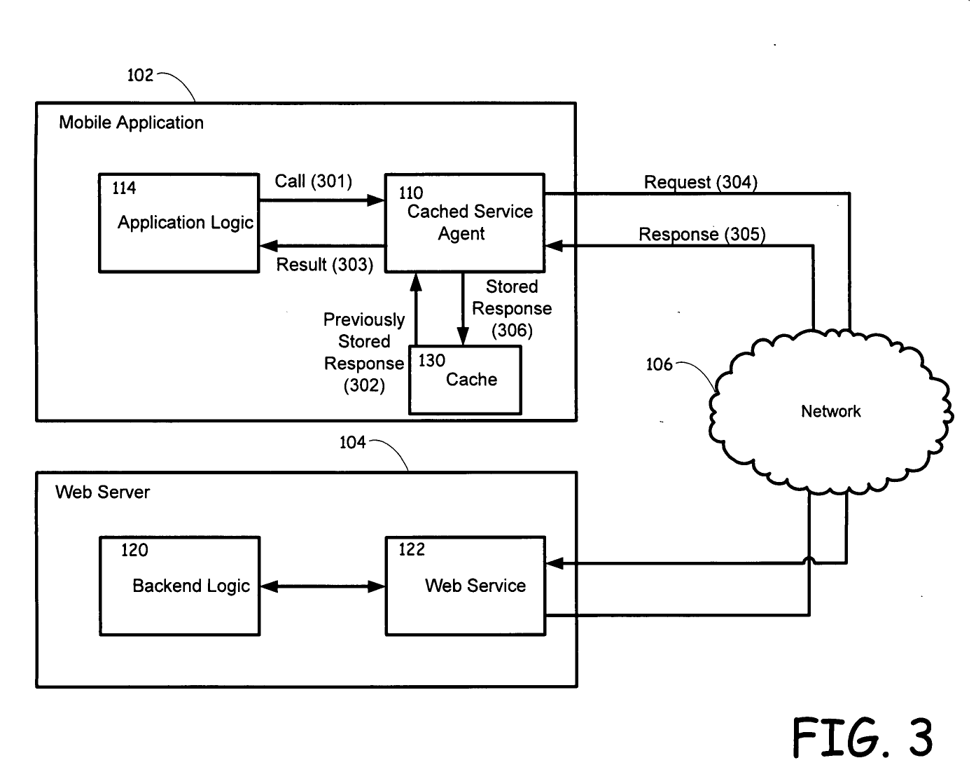

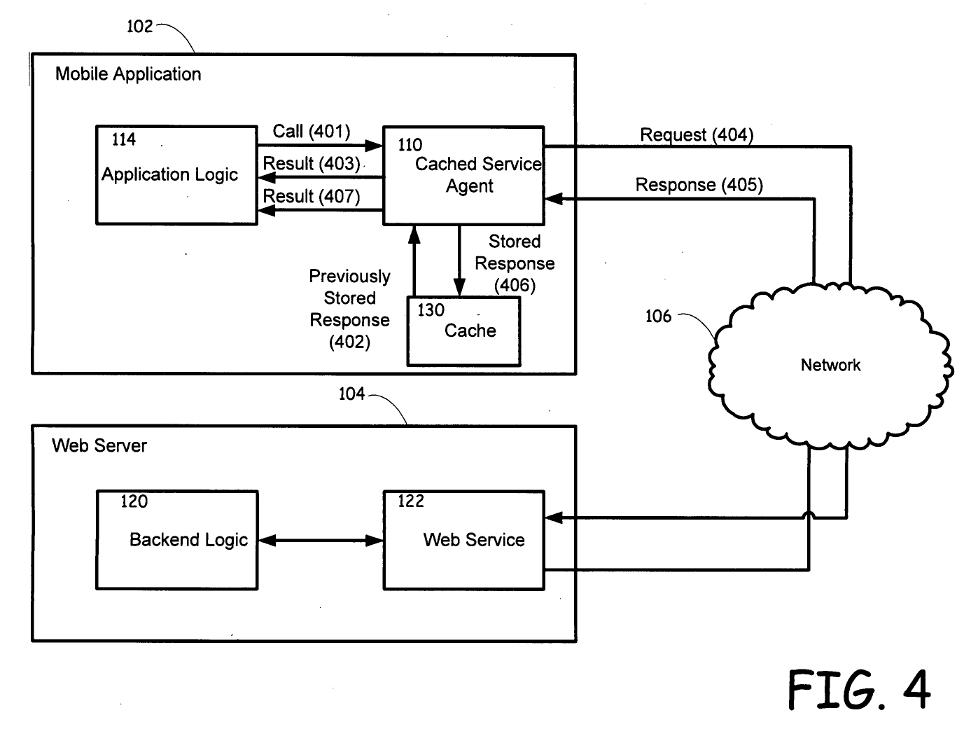

The operation of various embodiments of the present invention is presented in FIGS. 2-5 by presenting the various modes of operation. The embodiments include two modes of operation types: connected and disconnected. It should be understood that in an some embodiments, preference is given to online or connected modes of operation. Thus, when connectivity is present, the mobile application favors sending requests to the web server and receiving responses. However, it will also be appreciated that implementations can also be used in embodiments that give preference to offline or disconnected modes of operation. For instance, to conserve power, or to preserve data integrity in poor signal environments, to provide quicker responses, etc., the offline or disconnected mode of operation may be favored and utilized—even if some connectivity is present. Further yet, in other modes of operation a blend or mixture of these preferences can exist and, in the mode as illustrated in FIGS. 3 and 4, the two operation modes may operate contemporaneously.

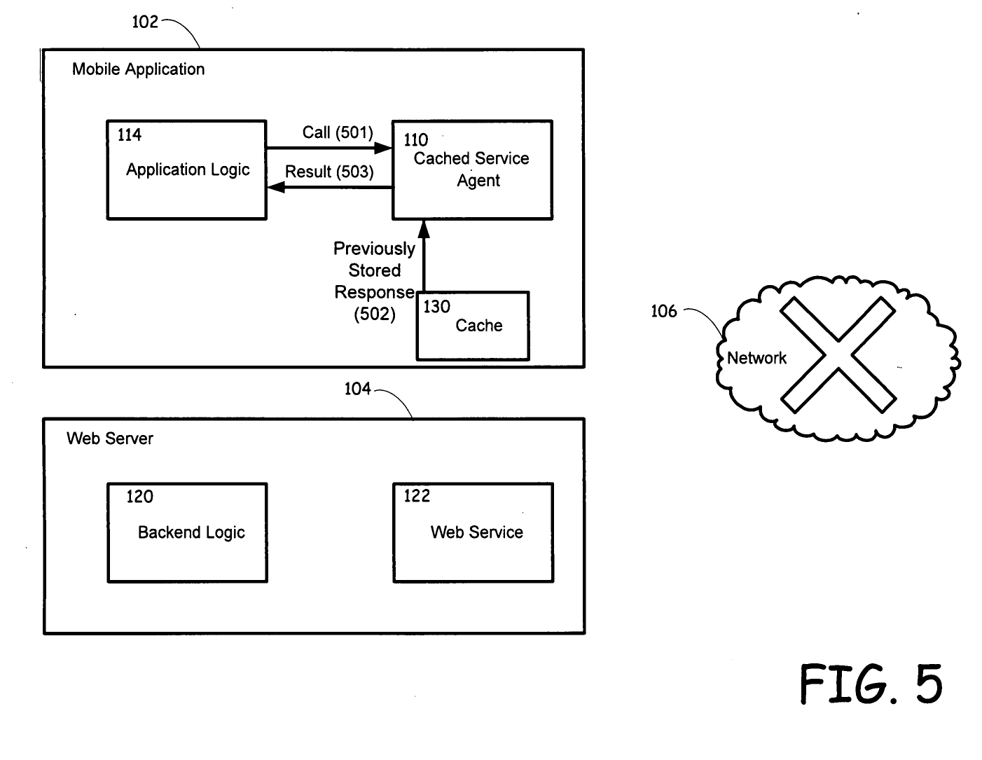

For the connect modes of operation described and illustrated in FIGS. 2, 3 and 4, connectivity to the web server is available and for FIG. 5, connectivity is not available. For the connected modes of operation, the responses are shown as always being stored into a cache. In addition, if a cached response is not available, the cached service agent 110 can provide a specific well-known error indicating this state; similar to invoking a regular web service call when there is no connection. It should be understood that the operation modes shown in FIGS. 2-5 can be steady-state modes, existing for considerable periods of time or, they may be transitory states and only existing momentarily before transitioning to another state. For instance, a preferred state of operation may be the state illustrated in FIG. 4. When connectivity is lost, the operation may temporarily transition to the state illustrated in FIG. 5 until connectivity is regained. Similarly, the offline state illustrated in FIG. 5 may be the preferred or default state and operation temporarily is transferred to one of the modes illustrated in FIGS. 2-4 only when it is determined that the cache does not include current or valid information for offline operation.

Finally, before examining the modes of operation in greater detail, it should be understood that from the perspective of mobile applications using the cached service agent 110, there is no substantial difference between being online or offline (connected or disconnected) because resulting information is provided to the application logic 114 in a consistent manner. To provide correct results, requested information is taken into consideration when storing and retrieving request/response pairs. Requests are considered to be unique based on an identifier, the value of which is calculated based on the data in the call. The calculation can be performed automatically by the cached service agent 110, or manually by the application logic 114. If manually specified, this system requires for a user, typically a developer, to supply a set of unique values that are used as input to a one-way function (hash) to create a global unique value. This identifying information is then stored locally by the cached service agent 110, and it is used for subsequent calls. These modes of operation are now described more specifically by looking at FIGS. 2-5.

FIG. 2 is a system block diagram illustrating a fully connected mode of operation for the system illustrated in FIG. 1. When the system is operating in a fully connected mode, the mobile application may obtain real-time responses directly in response to invoking the remote web service. More particularly, when the mobile application 102 is actuated (i.e., by a user interfacing to the mobile device, by an event triggered by another process, or by any other means) the application logic 114 first sends a call 201 directed towards the web service 122. The cached service agent 110 then forwards this call, converting it as necessary, as a request 202 towards the web service 122 through the network 106. In this connected state, the web service 122 responds in real-time with a response 203 that is provided to the cached service agent 110. The cached service agent 110 then provides this response 203 to the application logic 114, converting it as necessary, as the result 205 of the call 201. In response to the reception of the call, the mobile application can be notified, actuated, controlled or operated accordingly. For instance, the result may include data and content that is passed to the mobile application 102 and rendered in one or more forms or techniques by the mobile application on the mobile device. In addition, the cached service agent 110 stores this response 203 along with an identifier into a cache 130 as a stored response 204. The identifier can vary from embodiment to embodiment and in an exemplary embodiment, the identifier is a value that is calculated based on the content or the request 202. For instance, the content of the request can be fed into a hash algorithm to generate a unique or substantially unique identifier. It will be appreciated that although this aspect of the invention may in and of itself be considered novel, that other methods are also anticipated and may be employed, including but not limited to, sequence numbers, random numbers, etc. In an exemplary embodiment, it is desirable to be able to match responses to the requests that invoked them. However, in other embodiments it will be appreciated that this may not be a necessary element. Thus, in the fully connected mode of operation, the mobile application 102 obtains real-time responses directly via invocation of the remote web service 122. However, the responses are also stored in the cache 130 so that they can be used later, if necessary.

FIG. 3 is a system block diagram illustrating a connected mode of operation, similar to that illustrated in FIG. 2 for the system illustrated in FIG. 1, with the exception that previously stored responses are served up to the application logic 114. More particularly, the application logic 114 first sends a call 301 directed towards the web service 122. The cached service agent 110 then converts the call into a request (as necessary) and determines the identifier for that request. Using this identifier, the cached service agent 110 then retrieves a previously stored response 302 from the cache 130, formats or converts the response 302 into a result 303, and provides the result 303 to the application logic 114. Thus, the operation of the cached service agent 110 advantageously allows for the provision of previously stored responses to be served up to the application logic 114 in response to calls. In addition, the cached service agent 110 can, and typically does in this mode, forwards the request 304 towards the web service 122 through the network 106. In this connected state, the web service 122 responds in real-time with a response 305 which is provided to the cached service agent 110. The cached service agent 110 then stores this response 305 along with an identifier, the value of which is calculated based on the original request 304 into a cache 130 as a stored response 306. Advantageously, this mode of operation provides fast response times to the application logic 114 but still maintains up-to-date stored responses in the cache 130 for other, off-line modes of operation.

FIG. 4 is a system block diagram illustrating a connected mode of operation, similar to that illustrated in FIG. 3 for the system illustrated in FIG. 1, with the exception that previously stored responses and real-time response are both served up to the application logic. In essence, the mode of operation illustrated in FIG. 4 is a combination of the modes illustrated in FIG. 2 and FIG. 3.

More particularly, the application logic 114 first sends a call 401 directed towards the web service 122. The cached service agent 110 then converts or formats the call 401, as necessary, into a request. Based on the request, the cached service agent then generates an identifier and using this generated identifier, examines the cache 130 to determine if a previously stored response to this call 401, or request exists. If so, the cached service agent 110 retrieves the previously stored response 402 using the identifier generated based on the request, from the cache 130, converts or formats the previously stored response 402 into a result 403, and provides the result 403 to the application logic 114. Thus, the operation of the cached service agent advantageously allows for the provision of previously stored responses to be served up to the application logic 114 in response to calls. In addition, the cached service agent 110 can, and typically does in this mode, forwards the request 404 corresponding to the call 401 towards the web service 122 through the network 106. In this connected state, the web service 122 responds in real-time with a response 405 which is provided to the cached service agent 110. The cached service agent 110 then stores this response 405 along with an identifier, the value of which is calculated based on the request 404 into a cache 130 as a stored response 406. In addition, the cached service agent 110 converts or formats the response 405 into a result 407, and serves the result 407 to the application logic 114. Advantageously, this mode of operation provides fast response times to the application logic 114 but still maintains up-to-date stored responses in the cache 130 for other, off-line modes of operation. In addition, this mode of operation provides confirmation that the stored response is accurate, and if not, the real-time response can be used to augment the previously received result 403 that was extracted from the cache 130.

FIG. 5 is a system block diagram illustrating a disconnected mode of operation for the system illustrated in FIG. 1. In this mode of operation, connectivity through the network 106 is not available, either for a long period of time or simply transitionally.

More particularly, the application logic 114 first sends a call 501 directed towards the web service 122. The cached service agent 110 then converts or formats the call into a request, or otherwise determines or identifies a request associated with the call 501 and then generates an identifier based on the request. Using the identifier, the cache service agent 110 then examines the cache 130 to determine if a previously stored response to this request exists. In an exemplary embodiment, the cache 130 may include multiple responses which are indexed in some manner. For instance, the responses may be indexed by the call, the associated request, or a calculated value based on the call and/or request (such as a hash function) or a combination of one or more of these techniques. If it is determined that a previously stored response is in the cache, the cached service agent 110 retrieves the previously stored response 502 from the cache 130, converts or formats the response into a result 503 as necessary, and provides the result 503 to the application logic 114. Thus, the operation of the cached service agent 110 advantageously allows for the provision of previously stored responses to be served up to the application logic 114 in response to calls while operating in an offline configuration.

For the modes of operation described and illustrated in FIGS. 2, 3 and 4, the responses are shown as always being stored into the cache. In addition, if a cached response is not available during a disconnected mode of operation, the cached service agent 110 can provide a specific well-known error indicating this state to the application logic 114. This is similar to invoking a regular web service call when there is no connection (i.e., a 401 error).

It should be understood that although the cache 130 is shown and described as a simple memory storage device that can be indexed by an identifier, the cache 130 may also be implemented in other techniques. For instance, the cache could emulate the web server and operate by receiving requests and providing responses similar to the operation of the web server. Thus, in such an embodiment the interface to the cache and the web server would be identical to the cached service agent.

For applications using the cached service agent 110, there is no substantial difference between being online or offline because resulting information (results) is provided in a consistent manner. To provide correct results, requested information is taken into consideration when storing and retrieving request/response pairs or indexed responses. Requests are considered to be unique based on an identifier, the value of which can be calculated based on the data in the call or the data in the request depending on the embodiment. The calculation can be performed automatically by the cached service agent 110, or manually by the application logic 114. If manually specified, this system requires a user, typically a developer, to supply a set of unique values that are used as input to a one-way function (hash) to create a global unique value. This identifying information is then stored locally by the cached service agent 110, and it is used for subsequent calls.

An application can even benefit while running on a connected environment because the response time of an online application consuming web services is directly related to the web service execution time. Using the cached service agent 110 component, the online application experience is enhanced because it makes previous web service responses immediately available, while at the same time, asynchronously looking for authoritative web services responses. This design allows the application to continue execution, and transition seamlessly between online and offline states.

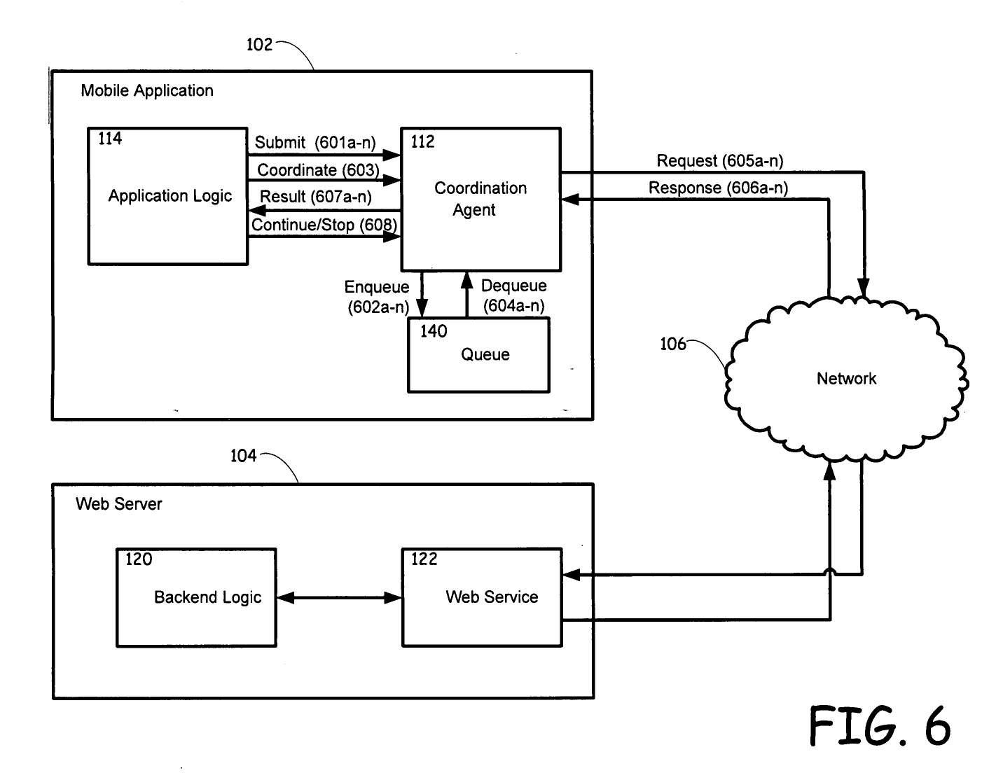

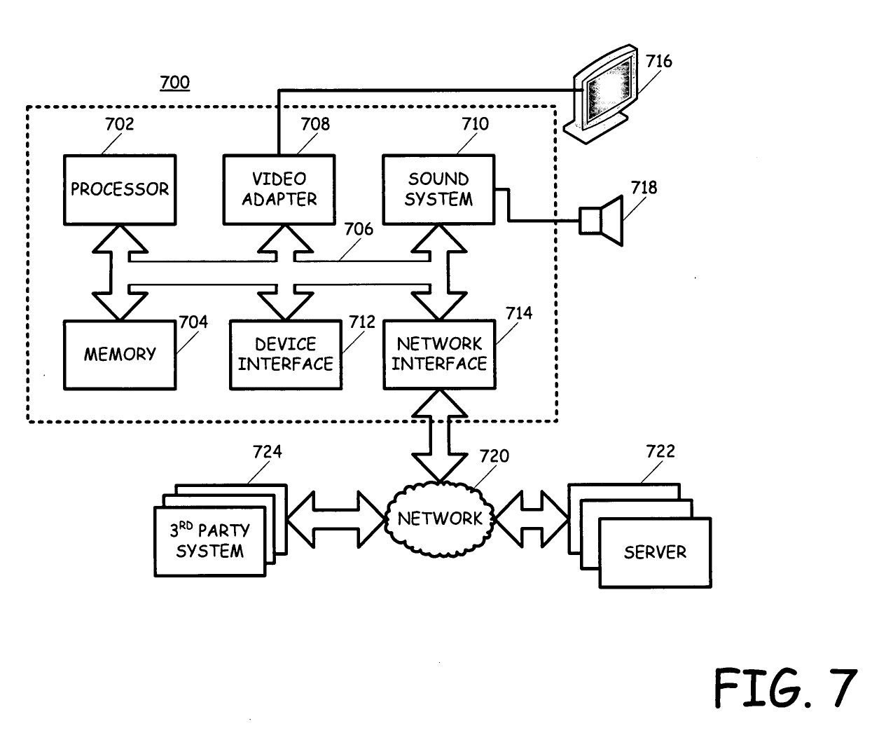

FIG. 6 is a system block diagram illustrating the operation of a coordination agent in a fully connected mode of operation for the system illustrated in FIG. 1. In general, this embodiment provides the application logic 114 with the ability to perform multiple related web service calls in a connection agnostic manner. While posting data, some applications require multiple web service calls to be executed sequentially and as an entity to satisfy a complex business operation. Although there are web services standards that address this issue, their implementation is not a requirement for service providers. In the absence of implementation of these standards on a server, a way to coordinate service calls from the client-side may be required. In a typical networked environment, if an activity is requested to be performed, the web server operates to make and control all of the service calls necessary for the activity. Unfortunately, in a mobile environment with potential disconnects, this structure can be quite problematic. Advantageously, in the illustrated embodiment, the application logic 114 operates to identify a sequence of service calls, or related service calls, that cooperate to perform or accomplish a desired activity. The coordination agent 112 then operates to feed these service calls to the web server to ensure the performance of the activity. More specifically, the application logic 114 submits one or more service calls 601a-n to the coordination agent 112. The nomenclature of “a-n” simply implies that one or more service calls can be provided through the submit function, although typically several service calls will be included in an activity. Several submissions are made serially with one for each service call. As the service calls are received by the coordination agent 112 through the submit 601a-n, the coordination agent queues 602a-n the service calls into the queue 140. Typically, the coordination agent 112 converts the service call into a request to be ultimately sent to the web server 104 and queues the requests into the queue 140.

Once the service calls 601a-n are submitted by the application logic 114, the application logic 114 then issues a coordinate request 603. The coordinate request 603 signals the coordination agent 112 that the set of service calls received via the submit 601a-n are part of an activity and that the activity is ready to be sent to the web server via network 106.

In general, the coordination agent 112 de-queues the requests 604a-n from the queue 140 sequentially and in the order that the requests were queued. More specifically, coordination agent 112 monitors the connectivity to determine if it is available. When the connection does become available, the coordination agent 112 triggers the execution of ready requests by extracting the requests 604a-n and transmitting them one by one to the web service 122. For each such request 605x, the web service 122 provides a response 606x. It should be appreciated that in the typical embodiment, a request 605 is transmitted and then a response 606 is received.

As the coordination agent 112 receives the responses 606a-n, it converts the response into a result 607a-n and provides it to the application logic 114. Thus, in one embodiment, for each request in the queue 140, the coordination agent 112 de-queues the request 604, sends the request 605 to the web service 122, receives a response 606, converts the response to a result 607 and provides the result to the application logic 114.

While the activity is being processed, the application logic 114 may issue a stop request. Basically, in one embodiment, processing the activity will continue unless an error occurs or the application logic 114 issues a stop signal 608. Thus, if an error is detected, the activity can be cancelled by the application logic 114. Additionally, coordination agent 112 may also cancel the activity whenever it detects any errors such as a failure of one request call or an exception from response handling of application logic 114. When an activity is canceled, all pending requests of the activity in queue 140 are de-queued and application logic 114 is notified for each canceled request. However, coordination agent 112 will not roll back the requests already sent to the web server 104. Application logic 114 is responsible to compensate the results of those executed requests.

The coordination agent 112 advantageously operates in a manner to survive application interruptions and/or disconnections. Because the requests are stored in the persisted queue 140, the coordination agent 112 knows what state it is in when it starts. Thus, if the application crashes, is interrupted or connectivity is lost, the coordination agent can resume processing the activity from where it had left off, the last success or last valid point. Once the activity processing is completed, application Logic 114 will have all the related responses, or can compensate due to an incomplete process.

Thus, the described embodiment allows a mobile application 102 to process an activity requiring several service calls. The web server 104 has no knowledge of the multiple related web service calls. It simply receives one service call at a time and responds accordingly. If the connectivity is disrupted during the performance of an activity, the coordination agent 112 can pick up where it left off and continue the performance of the activity by making service calls.

Referring back to FIG. 1, it will also be appreciated that embodiments may include the provision of external notifications to operate as an indicator of the state of the cached responses. For instance an external request 160 may be received by the cache service agent 110. The external request may be triggered by a variety of reasons but in general, it operates to indicate that the data in the cache (stored response) are either invalid or need to be updated. For instance, this may occur if substantial changes are made to the web server. Thus, further operation of the system will require the requests to be sent external of the mobile application to ensure that the correct or updated responses are received. In one embodiment, the external request 160 may be used to cause the entire cache to be flushed or erased. In yet another embodiment, a certain class, category, specific responses or responses that relate to a specific functionality of the web service may be erased. Some embodiments may simply impose a minimum amount of time that must pass, or a minimum number of transactions that must occur before the offline mode of operation may be entered or activated again.

In some embodiments, the coordination agent 112 agent may provide a request 162 to the cache service agent 110 that operates similar to the external request 160. The CA request 162 indicates that the cache service agent 110 must make real calls to the web server 104 rather than extracting responses from the cache 130. For example, a cache 130 may include information or responses to a job query. However, if the user posts that a job has been completed, then this is an indication that the data in the cache is now no longer current and needs to be updated. This aspect of the invention can also be applied for activities including multiple service calls. In either event, if the coordination agent 112 is aware that the cache is no longer current; the cache service agent 110 can be forced to make real calls to the web server 104 until such time that the cache 130 is updated. External requests can also be triggered by the application logic 114 with the purpose to either invalidate data in the cache as an example.

FIG. 7 is a general block diagram illustrating a hardware/system environment suitable for various embodiments or portions of embodiments. A general computing platform 700 is shown as including a processor 702 that interfaces with a memory device 704 over a bus or similar interface 706. The processor 702 can be a variety of processor types including microprocessors, micro-controllers, programmable arrays, custom IC's etc., and may also include single or multiple processors with or without accelerators or the like. The memory element 704 may include a variety of structures, including but not limited to RAM, ROM, magnetic media, optical media, bubble memory, FLASH memory, EPROM, EEPROM, etc. The processor 702 may also interface to a variety of elements including a video adapter 708, sound system 710, device interface 712 and network interface 714. The video adapter 708 is used to drive a display, monitor or dumb terminal 716. The sound system 710 interfaces to and drives a speaker or speaker system 718. The device interface 712 may interface to a variety of devices (not shown) such as a keyboards, a mouse, a pin pad, and audio activate device, a PS3 and/or other game controller, as well as a variety of the many other available input and output devices. The network interface 714 is used to interface the computing platform 700 to other devices through a network 720. The network may be a local network, a wide area network, a global network such as the Internet, or any of a variety of other configurations including hybrids, etc. The network interface may be a wired interface or a wireless interface. The computing platform 700 is shown as interfacing to a server 722 and a third party system 724 through the network 720.

Thus, those skilled in the art can appreciate how the various embodiments may be implemented on one or more platforms as illustrated in FIG. 7. For instance, the application logic 114 may be implemented as a module created from software instructions, firmware instructions, or may exist as a single or set of hardware components that operate to perform a certain function. The cache 130 may consist of software defined structures residing in memory 704, may be hardware caches with dedicated address and data lines or may be modules or components that provide caching functionality. The web server 104 may be implemented on a platform similar that the platform illustrated in FIG. 7, as well as multiple similar platforms operating in parallel or in unison. As such, the web server 104 may actually include one or more hardware platforms that provide various web services 122 or operation together to provide one or more web services.

The cached service agent 110 and the coordination agent 112 may interface to the network 106 through network interfaces similar to the network interface 714. As another example, the web server 104 may be represented as server 722 and the mobile device housing the mobile application 102 may be represented by device 700.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The embodiments have been described using detailed descriptions, each of which are provided by way of example and are not intended to limit the scope of the invention. The described embodiments comprise different features, not all of which are required in all embodiments. Some embodiments utilize only some of the features or possible combinations of the features. Variations of embodiments that are described comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A system for providing seamless operation for a mobile application operating on a mobile device, the mobile application utilizing web services of a web server when the mobile device is connected to the web server, and the seamless operation being provided when the mobile device is disconnected from the web server, the system comprising:
an application logic unit that interfaces to the mobile application;
a cached service agent unit that is communicatively coupled to the application logic unit, a cache within a memory device and to a web server through a network, the cached service agent unit being implemented by a processing unit and operative to:
receiving a call generated as the result of an operation of the mobile device;
translating the call into a request and forwarding the request to a web server over the network;
receiving a response from the web server, the response being associated with the request;
generating an identifier that is associated with the request;
storing the identifier along with the response into the cache;
generating a result from the response associated with the call; and
communicating the result to the application logic unit.

2. The system of claim 1, wherein the application logic unit is implemented by a processing unit and is operative to:
detect an operation of the mobile application;
generate a call based on the detected operation;
provide the call to the cached service agent unit;
receive a result from the cached service agent unit, the result being received in response to the call; and
interfacing with the mobile application in a manner based on the result.

3. The system of claim 2, wherein if the cached service agent unit is not communicatively coupled to the web server, the cached service agent unit is further operative to:
examine the cache for a response associated with the generated identifier;
if a response is identified, generate a local result based on the identified response; and
provide the local result to application logic unit.

4. The system of claim 2, wherein the cached service agent unit is further operative to:
examine the cache for a response associated with the generated identifier;
if a response is identified, generate a local result based on the identified response; and
provide the local result to application logic unit.

5. The system of claim 4, wherein the application logic unit is further operative to:
receive the local result from the cached service agent unit, the local result being received in response to the call and being received prior to the result; and
interfacing with the mobile application in a manner based on the local result.

6. The system of claim 5, wherein the application logic unit is further operative to:
receive the result from the cached service agent unit, the result being received in response to the call and being received subsequently to receiving the local result; and
interfacing with the mobile application in a manner based on the result to update the mobile application is the result is different from the local result.

7. The system of claim 1, wherein the cache service agent unit further comprises a coordination agent unit that is operative to:
receive a batch of calls from the application logic unit;
store the batch of calls into a queue;
monitor the network connection to determine when the mobile application is connected to the web server;
if connectivity is available, processing the batch of calls in sequence one at a time; and
if connectivity is interrupted, identifying a last success point and, when connectivity is restored, continuing with processing the batch of calls in sequence from the last success point.

8. The system of claim 7, wherein if the cached service agent unit is not communicatively coupled to the web server, the cached service agent unit is further operative to:
examine the cache for a response associated with the generated identifier;
if a response is identified, generate a local result based on the identified response; and
provide the local result to application logic unit.

9. The system of claim 8, wherein the application logic unit is further operative to:
receive the local result from the cached service agent unit, the local result being received in response to the call and being received prior to the result; and
interfacing with the mobile application in a manner based on the local result.

10. The system of claim 9, wherein the application logic unit is further operative to:
receive the result from the cached service agent unit, the result being received in response to the call and being received subsequently to receiving the local result; and
interfacing with the mobile application in a manner based on the result to update the mobile application is the result is different from the local result.

11. A method for providing seamless operation of a web service dependent mobile application, the method comprising the steps of:
detecting an operation of the mobile application;
generating a call based on the detected operation;
translating the call into a request;
forwarding the request to a web server over a network;
receiving a response from the web server, the response being associated with the request;
generating an identifier that is associated with the request;
storing the identifier along with the response into a memory based cache;
generating a result from the response associated with the call; and
providing the result to the mobile application.

12. The method of claim 11, further comprising the steps of:
prior to performing the step of forwarding the request to a web server over a network, determining that there is no connectivity with the network;
examining the cache for a response associated with the identifier generated in the generating step;
if a response is identified, generating a local result based on the identified response; and
providing the local result to the mobile application.

13. The method of claim 12, further comprising the steps of:
subsequent to the step of providing the local result to the mobile application receiving the response from the web server and if the result for the received response would be different than the local result, continuing with the step of providing the result to the mobile application.

14. The method of claim 12, further comprising the steps of:
subsequent to the step of providing the local result to the mobile application, receiving the response from the web server and if the result for the received response is the same as the local result, skipping the step of providing the result to the mobile application.

15. The method of claim 11, wherein if connectivity with the network is interrupted, an offline mode of operation is activated which comprises the steps of:
examining the cache for a response associated with the generated identifier;
if a response is identified, generate a local result based on the identified response; and
provide the local result to application logic unit.

16. The method of claim 15, wherein when the offline mode of operation is activated, further comprising the steps of:
receiving an external notification;
in response to the external notification, exiting the offline mode of operation and preventing entrance to the offline mode of operation until particular criteria are satisfied.

17. A method for providing seamless operation of a web service dependent mobile application, the method comprising the steps of:
detecting an operation of the mobile application;
generating a plurality of calls based on the detected operation;
storing the plurality of calls into a queue;
receiving an indication that the plurality of calls are ready for execution;
for each call in the queue in sequence:
extracting the call from the queue;
translating the call into a request;
forwarding the request to a web server over a network;
generating a result from the response associated with the call; and
receiving a response from the web server, the response being associated with the request;
providing the result to the mobile application.

18. The method of claim 17, wherein if the connection to the network is interrupted, further comprising the steps of:
storing a last valid state that existed prior to the interrupted connection;
detecting the resumption of connectivity to the network; and
continuing the step of extracting the call from the queue starting at the last valid state.

19. The method of claim 18, further comprising the steps of:
generating an identifier that is associated with each request; and
storing the identifier along with the response into a memory based cache.
